(19) United States
(12) Patent Application Publication
(10) Pub. No.: US 2006/0263154 A1
(43) Pub. Date: Nov. 23, 2006

(54) Door core drilling apparatus

(76) Inventor: Mark W. Fuller, Houston, TX (US)

Correspondence Address: PATTERSON & SHERIDAN, L.L.P., 3040 POST OAK BOULEVARD, SUITE 1500, HOUSTON, TX, 77056, US

(21) Appl. No.: 11/407,876

(22) Filed: Apr. 19, 2006

Related U.S. Application Data
(60) Provisional application No. 60/672,887, filed on Apr. 19, 2005.

(51) Int. Cl. B23B 39/00

(52) U.S. Cl. 408/103

(57) ABSTRACT

A method and apparatus for providing a bore across a width of a door to make an interconnection on opposite ends of the door, comprising a head assembly, a hinge mortise fixture assembly, and a drill motor guide assembly. Also, a method and apparatus for providing a bore across a width of a door to make an interconnection on opposite ends of the door, comprising applying a head assembly, a hinge mortise fixture assembly, and a drill motor guide assembly to a door, and drilling a bore into the door.

### CROSS-REFERENCE TO RELATED APPLICATIONS

This application claims benefit of U.S. provisional patent application Ser. No. 60/672,887, filed Apr. 19, 2005.

### BACKGROUND OF THE INVENTION

1. Field of the Invention

Embodiments of the present invention generally relate to a method and apparatus to install door hardware. Specifically, extending a small hole through the width of a door using a guide is described.

2. Description of the Related Art

As electronic and other security means are increasingly designed to extend through the width of a door, an effective, safe, secure method for drilling a narrow channel across the width of a door has become more important. Factors that influence the selection of a jig and drill motor guide include the width of the door panel, the thickness of the door panel, the diameter and flexibility of the extended drill bit and shaft, and the material of the core of a door. An effective method that can be used with a door that has been in service with conventional hardware is also desirable. Doors often have widths that are longer than three feet and thicknesses of 1 ⅜ inch to 1 ¾ inch.

Specialty hardware has been developed to attempt to effectively channel through the width of a door including long, slender drill bits and templates. Unfortunately, effective templates have not been developed that 1) do not mar the door, 2) provide sufficient guidance for a hand held drill, or 3) remain properly aligned upon application in tight passageways with limited access. Friction mounted jigs may be selected, but they are prone to movement once in use. Conventional hardware addresses these problems by clamping to the surface of the door, wrapping around the edge or end of a door utilizing friction for mounting the guide. This is similar to tightening a common C-clamp. These clamps may be applied too tightly, resulting in finish damage to the door surface. Repositioning may also be required if the clamp is not applied with enough force. Repositioning errors may require additional corrective measures throughout the installation of the door hardware.

Thus, a hardware system that is self-aligning, avoids movement, and provides a guide for tunneling through the span of a door with proper alignment is needed. The guide needs to be able to work with doors that have already been installed into service with conventional hardware, such as when a door is upgraded from mechanical to electromechanical operation.

### SUMMARY OF THE INVENTION

The present invention generally provides a bore across a width of a door to make an interconnection on opposite ends of the door. One embodiment provides method and apparatus for providing a bore across a width of a door to make an interconnection on opposite ends of the door, comprising a head assembly, a hinge mortise fixture assembly, and a drill motor guide assembly. Another embodiment provides a method and apparatus for providing a bore across a width of a door to make an interconnection on opposite ends of the door, comprising applying a head assembly, a hinge mortise fixture assembly, and a drill motor guide assembly to a door, and drilling a bore into the door.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a three dimensional view of one embodiment of a head assembly.

FIG. 2 is a three dimensional view of one embodiment of a hinge mortise fixture assembly.

FIG. 3 is a three dimensional view of one embodiment of a drill motor guide assembly.

FIG. 4 is a three dimensional view of one embodiment of a head assembly, hinge mortise fixture assembly, and a drill motor guide assembly.

FIG. 5 is a three dimensional view of an additional embodiment of a head assembly for cylindrical door locks.

FIG. 6 is a three dimensional view of an additional embodiment of a head assembly.

### DETAILED DESCRIPTION

The present invention provides a method and apparatus for using a drilling jig and drill guide for providing a bore across the width of a door to make the interconnection of electronic door hardware on opposite ends of a door. The bore can be used for electrical components for security systems. The jig and guide for the preparation of a door may be used with a hand held power drill when other hardware has already been installed. The jig and guide may consist of three assemblies; head assembly, a hinge mortise fixture assembly, and drill motor guide assembly.

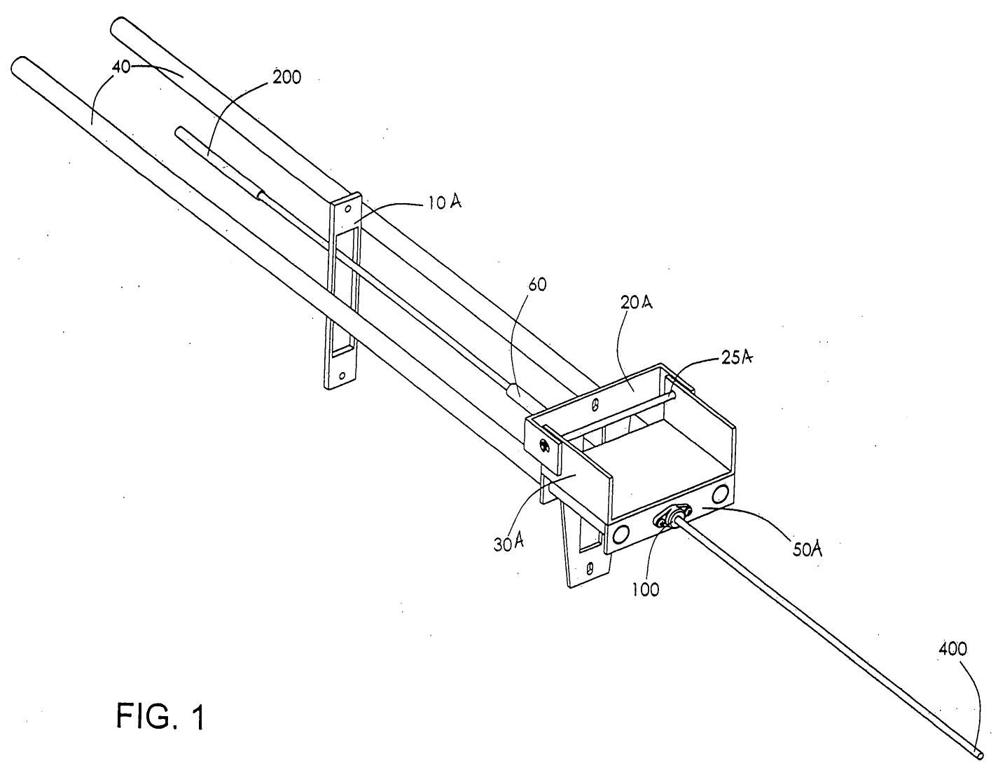

FIG. 1 is a three dimensional view of one embodiment of a head assembly. The base plate 10A fits into a lock faceplate mortise in the edge of the latching end of a door and fastens to the door using the same screw holes which are used to secure a lock body into the door. This provides a foundation to mount a head assembly mounting plate 20A the door. Thus, the head assembly does not make contact with the surrounding finished surfaces of the door. The head assembly mounting plate 20A fastens to the base plate 10A and is the supporting member for a pivoting drill bit and guide member assembly 30A.

The pivoting drill bit and guide member assembly 30A is connected to the head assembly mounting plate 20A by a pin 25A that allows it to rotate freely to the desired angle of the hinge or other location of power transfer at the opposite end of the door panel. The pivoting drill bit and guide member assembly 30A has three elements: a means for supporting the shaft of an extended drill bit 50A; an adjustable tube 60 that minimizes deflection of the extended drill bit as the bit makes contact with the surface of the door, i.e. the point of entry; and two female guide members 40 to provide for interconnection between the head assembly and the hinge mortise fixture assembly, to receive the male guide members of the drill motor guide assembly, and to provide the proper angel and parallel travel for the drill motor guide assembly in relation to the surfaces of the door panel. The end of the shaft 400 of the extended drill bit 200 can be tightened into the chuck of a common hand held power drill.

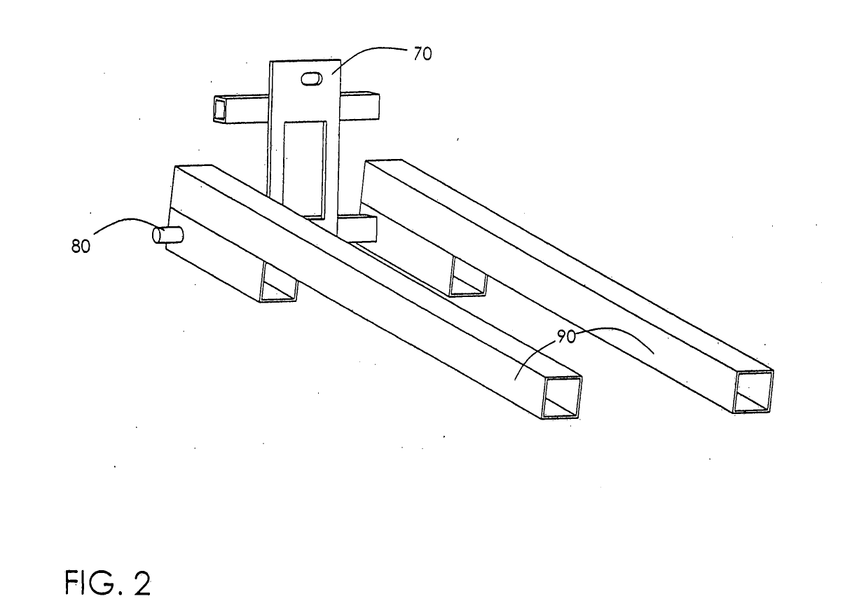

FIG. 2 is a three dimensional view of one embodiment of a hinge mortise fixture assembly. A hinge mortise fixture 70 fits into a hinge mortise in the edge of a door and fastens to the door using the same screw holes for fastening a hinge to the door. Two guide member receiving tubes 90 are connected to the hinge mortise fixture 70 by a pin 80 that enables them to rotate freely to any angle necessary to receive the guide members on the pivoting drill bit and guide member assembly. This provides interconnection between the head assembly and the hinge mortise fixture assembly and ensures parallel travel at the proper angle to drill through the core of the door.

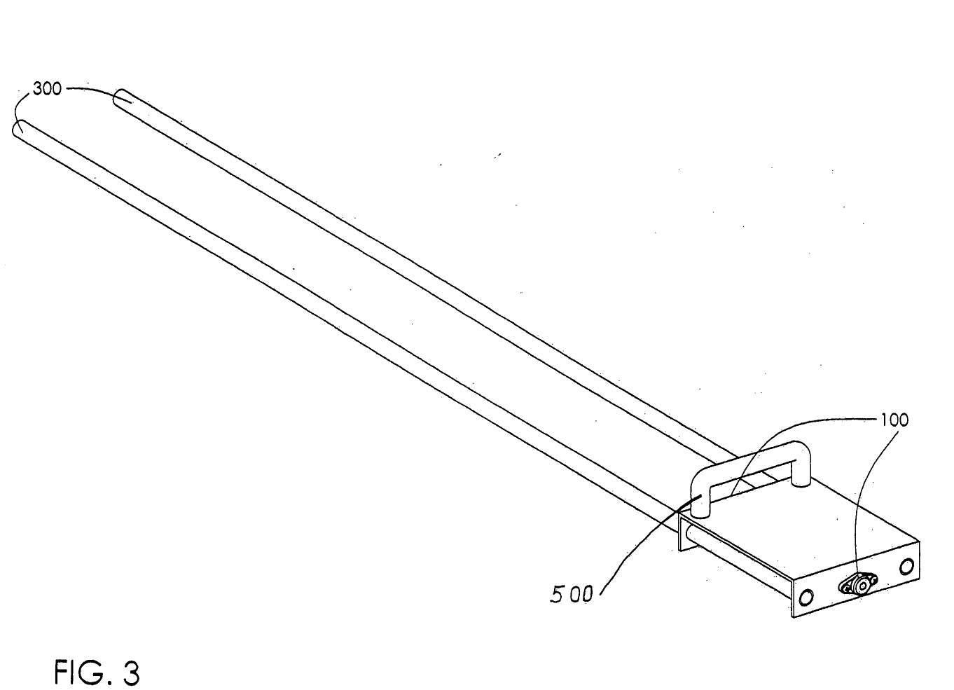

FIG. 3 is a three dimensional view of one embodiment of a drill motor guide assembly. A drill bit is fed through the shaft support bearings 100 in the drill motor guide assembly. The two male guide members 300 can be inserted into the female guide members in the pivoting drill bit and guide member assembly. A handle 500 may be used to push the drill motor guide assembly.

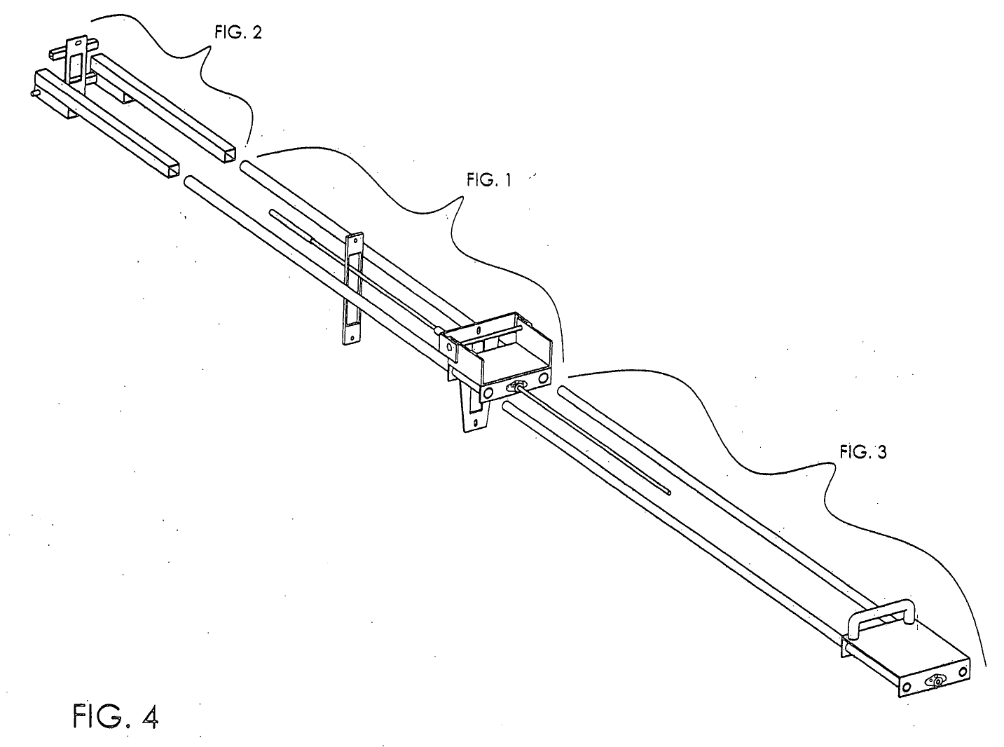

FIG. 4 is a three dimensional view of one embodiment of a head assembly, hinge mortise fixture assembly, and a drill motor guide assembly. The view shows how the three assemblies work together.

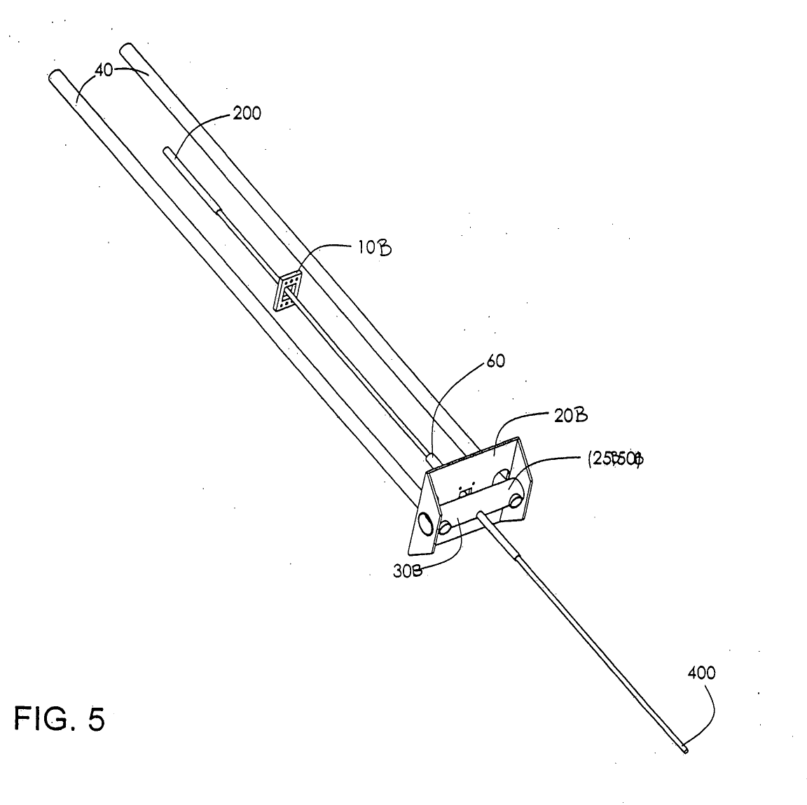

FIG. 5 is a three dimensional view of an additional embodiment of a head assembly for cylindrical door locks. FIG. 5 is comparable to FIG. 1, except that the design of the lock body is different and thus the base plate 10B, head assembly mounting plate 20B, pin 25B, pivoting drill bit and guide member assembly 30B, and a means for supporting the shaft of an extended drill bit 50B have slightly different shapes and sizes to account for the different lock body design.

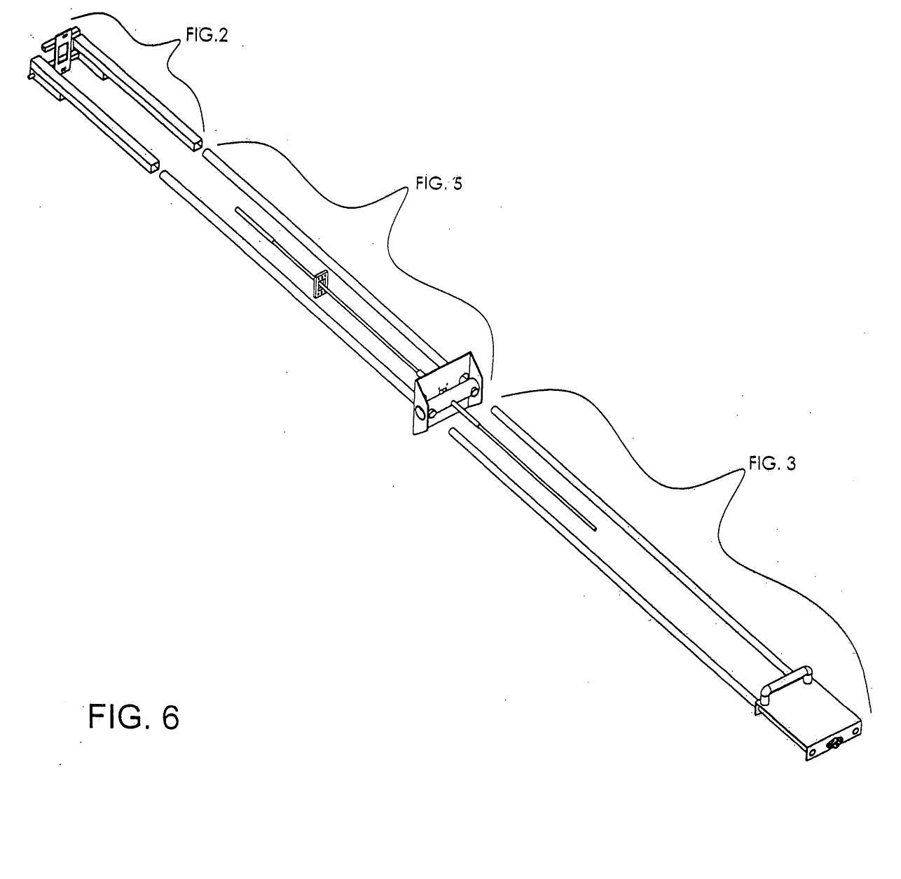

FIG. 6 is a three dimensional view of an additional embodiment of a head assembly, illustrating how the FIG. 5 lock body design and surrounding equipment relate to the components illustrated by FIGS. 2 and 3. FIG. 6 is comparable to FIG. 4, except that the head assembly is comparable to the head assembly of FIG. 5.

In operation, the jig and guide may be used on a door that has been already installed into service. To use the jig and guide, it may be necessary to remove the existing door hardware to provide appropriate door services to use the guides. Once the head assembly and the hinge fixture assembly are attached to a door, the installation of the door core-drilling jig is complete. It is not necessary to push the drill and the drill motor guide assembly together at the same time.

There are several advantages to this system. The guide assembly provides straight, guided movement and support for the extended drill bit. Utilizing the mortises rather than clamping to the door protects the surfaces of the door and provides stability for drilling a proper bore across the door. This method also takes advantage of the removal of door hardware that will most likely have to be removed for an upgrade in security devices that will utilize the bore.

While the foregoing is directed to embodiments of the present invention, other and further embodiments of the invention may be devised without departing from the basic scope thereof, and the scope thereof is determined by the claims that follow.

1. An apparatus for providing a bore across a width of a door to make an interconnection on opposite ends of the door, comprising:
a head assembly;
a hinge mortise fixture assembly; and
a drill motor guide assembly.

2. The apparatus of claim 1, wherein the head assembly does not contact a finished surface of the door.

3. The apparatus of claim 1, wherein the head assembly comprises:
a base plate;
a mounting plate;
a pin; and
a pivoting drill bit and guide member.

4. The apparatus of claim 1, wherein the hinge mortise fixture assembly comprises:
a hinge mortise fixture;
at least one guide member extending tubes; and
a pin.

5. The apparatus of claim 1, wherein the drill motor guide assembly comprises:
at least one shaft support bearing;
at least one male guide bearing; and
a handle.

6. A method for providing a bore across a width of a door to make an interconnection on opposite ends of the door, comprising:
applying a head assembly, a hinge mortise fixture assembly, and a drill motor guide assembly to a door; and
drilling a bore into the door.

7. The method of claim 6, further comprising removing existing hardware from the door.

8. The method of claim 7, further comprising installing an electronic security device to the door.
